(19) United States
(12) Patent Application Publication
(10) Pub. No.: US 2006/0196756 A1
(43) Pub. Date: Sep. 7, 2006

(54) Operation unit for portable device

(75) Inventors: Toshiyuki Ohmori, Saitama-ken (JP); Tetsuji Kuroda, Kanagawa-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/366,567

(22) Filed: Mar. 3, 2006

(30) Foreign Application Priority Data
Mar. 4, 2005 (JP) 2005-061206

(51) Int. Cl. H01H 13/72

(52) U.S. Cl. 200/5 A

(57) ABSTRACT

An operation unit for a portable device is provided. The operation unit includes a display panel with a display area that is arranged on a body of the portable device and is adapted to electrically display arbitrary information, a plurality of operation buttons that are arranged in a vicinity of the display panel on the body of the portable device, a plurality of fixed lines, each of which is extended from each of the plurality of operation buttons to the display area of the display panel, a display controlling system that is adapted to control an operation of the portable device. The display controlling system displays function indexes, each of which indicates a function assigned to one of the plurality of the operation buttons based on an operation mode that the device is in so that each of the function indexes is displayed in an independent area on the display panel. The display controlling system displays a plurality of displayed lines, each of which is displayed on the display area of the display panel to visually connect the independent area of the display panel to one of the plurality of operation buttons that is assigned the function.

### BACKGROUND OF THE INVENTION

The present invention relates to an operation unit for a portable device such as a digital camera and a PDA (personal digital assistance), and particularly to an operation unit having a plurality of operating buttons each of which is provided with a plurality of functions to operate the device.

Generally, a portable device is equipped with a limited number of operation buttons, and each of those buttons is provided with various functions to configure operation settings of an operational mode and to operate the device according to the operation settings. Such a device is required to have systems to notify a user of the function currently assigned to the button depending on the operation mode that the device is in.

An example of such a device is disclosed in Japanese Patent Provisional Publication No. 2004-088167. In the publication, a digital camera having an operation unit and operation buttons is disclosed, and a function of each of the operation buttons arranged at a periphery of an LCD (liquid crystal display) panel is illustrated by characters that are displayed on the LCD correspondingly in a vicinity of each of the buttons.

In the operation unit disclosed in the above-referenced publication, however, the characters displayed on the LCD and the buttons corresponding to the characters are generally arranged separately from each other, thus it is often difficult for the user to apprehend the correspondence of the displayed characters to the operation buttons. In addition, the digital camera disclosed in the above-referenced publication employs small number of characters to describe the function corresponding to the button on the display, as shown in FIG. 4 of the publication, however, certain functions may require more detailed description with greater number of letters and characters. In such a case, display areas required for the description of the functions tend to be greater, thus all of the description may not be arranged in the vicinity of each of the operation buttons, and it may become even more difficult to link the displayed description to the operation buttons.

### SUMMARY OF THE INVENTION

The present invention is advantageous in that an operation unit for a portable device capable of intuitively linking characters on a display screen that describe functions of operation buttons with the operation buttons of the device corresponding to the functions is provided. Specifically, the present invention is advantageous in that an operation unit capable of linking the descriptions of the functions with greater volume of texts displayed on the display screen with the operation buttons corresponding to the functions easily is provided.

According to an aspect of the present invention, an operation unit for a portable device is provided. The operation unit includes a display panel with a display area that is arranged on a body of the portable device and is adapted to electrically display arbitrary information, a plurality of operation buttons that are arranged in a vicinity of the display panel on the body of the portable device, a plurality of fixed lines, each of which is extended from each of the plurality of operation buttons to the display area of the display panel, a display controlling system that is adapted to control an operation of the portable device. The display controlling system displays function indexes, each of which indicates a function assigned to one of the plurality of the operation buttons based on an operation mode that the device is in so that each of the function indexes is displayed in an independent area on the display panel. The display controlling system displays a plurality of displayed lines, each of which is displayed on the display area of the display panel to visually connect the independent area of the display panel to one of the plurality of operation buttons that is assigned the function.

Optionally, each of the function indexes may be a graphic symbol that represents the function assigned to one of the plurality of operation buttons.

Optionally, each of the function indexes may be a descriptive text that explains the function assigned to one of the plurality of operation buttons.

According to an aspect of the present invention, a digital camera is provided. The digital camera includes an operation unit having a display panel with a display area that is arranged on a body of the digital camera and is adapted to electrically display arbitrary information, a plurality of operation buttons that are arranged in a vicinity of the display panel on the body of the digital camera, a plurality of fixed lines, each of which is extended from each of the plurality of operation buttons to the display area of the display panel, a display controlling system that is adapted to control an operation of the digital camera. The display controlling system displays function indexes, each of which indicates a function assigned to one of the plurality of the operation buttons based on an operation mode that the digital camera is in so that each of the function indexes is displayed in an independent area on the display panel. The display controlling system displays a plurality of displayed lines, each of which is displayed on the display area of the display panel to visually connect the independent area of the display panel to one of the plurality of operation buttons that is assigned the function.

According to an aspect of the present invention, a portable device is provided. The portable device includes an operation unit having a display panel with a display area that is arranged on a body of the portable device and is adapted to electrically display arbitrary information, a plurality of operation buttons that are arranged in a vicinity of the display panel on the body of the portable device, a plurality of fixed lines, each of which is extended from each of the plurality of operation buttons to the display area of the display panel, a display controlling system that is adapted to control an operation of the portable device. The display controlling system displays function indexes, each of which indicates a function assigned to one of the plurality of the operation buttons based on an operation mode that the portable device is in so that each of the function indexes is displayed in an independent area on the display panel. The display controlling system displays a plurality of displayed lines, each of which is displayed on the display area of the display panel to visually connect the independent area of the display panel to one of the plurality of operation buttons that is assigned the function.

### BRIEF DESCRIPTION OF THE DRAWINGS

FIG. 1 shows a block diagram illustrating a signal processing system of a digital camera according to an embodiment of the invention.

FIG. 2 shows a plane view of a rear surface of the digital camera according to the embodiment of the invention.

FIG. 3 shows an enlarged view of an LCD and surroundings thereof according to the embodiment of the invention.

FIG. 4 shows another enlarged view of the LCD and surroundings thereof according to the embodiment of the invention.

### DETAILED DESCRIPTION OF THE EMBODIMENTS

Hereinafter, referring to the accompanying drawings, an operation unit for a digital camera 100 according to an illustrative embodiment of the invention will be described.

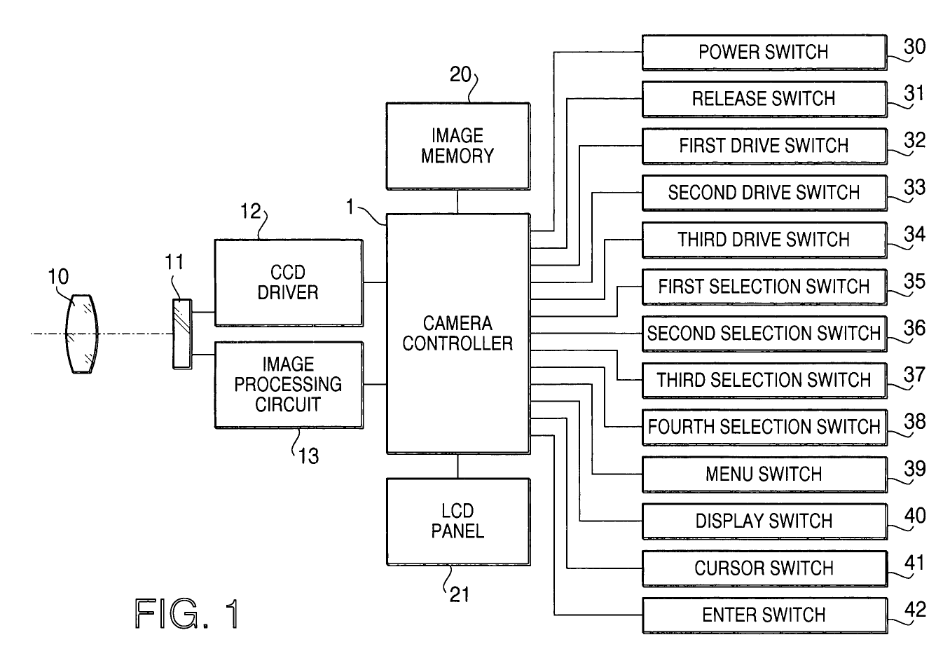

FIG. 1 shows a block diagram illustrating a signal processing system of the digital camera 100 according to the embodiment of the invention. As shown in FIG. 1, the signal processing system of the embodiment includes a camera controller 1 (having a display controlling system) that controls an entire camera operation, a photographing system for obtaining image signals, an image memory 20 for storing image data obtained through the photographing system, an LCD panel 21 for displaying images, setting menus, and the like. The signal processing system further includes various switches that are used for setting an operational mode of the digital camera 100.

The photographing system is provided with an image capturing element 11 having a CCD (charge-coupled device) image sensor to capture an object image through a photographing lens 10, and a CCD driver 12 that drives the image capturing element 11 according to an instruction from the camera controller 1. The photographing system further includes an image processing circuit 13 that processes the image signals output from the image capturing element 11 and transmits the signals to the camera controller 1.

The switches include a power switch 30, a release switch 31, a first through a third drive switches 32, 33, 34, a first through a fourth selection switches 35, 36, 37, 38, a menu switch 39, a display switch 40, a cursor switch 41, and an enter switch 42. The power switch 30 is operated when power supply to the camera 100 is switched on and off, and the release switch 31 is operated when the object image is photographed. The first drive switch 32 is operated for strobe device setting, the second drive switch 33 is for setting a self-timer and remote photographing, and the third drive switch 34 is for setting macrophotographing mode and telephotographing mode, and the like. Each of the selection switches 35-38 are assigned a function based on a photographing mode that the camera 100 is in. The menu switch 39 is operated for displaying a setting screen to configure various camera settings. The display switch 40 is used for switching one of the setting screens shown on the LCD panel 21 to another setting screen. The cursor switch 41 is used to move a cursor displayed in the setting screen on the LCD panel 21 for specifying a camera setting, while the enter switch 42 is used to confirm the setting specified by operating the cursor. It should be noted that the cursor switch 41 includes four switches, each of which is used to move the cursor in one of four directions (i.e., up, down, left, and right), and in FIG. 1, the four switches are combined in one switch.

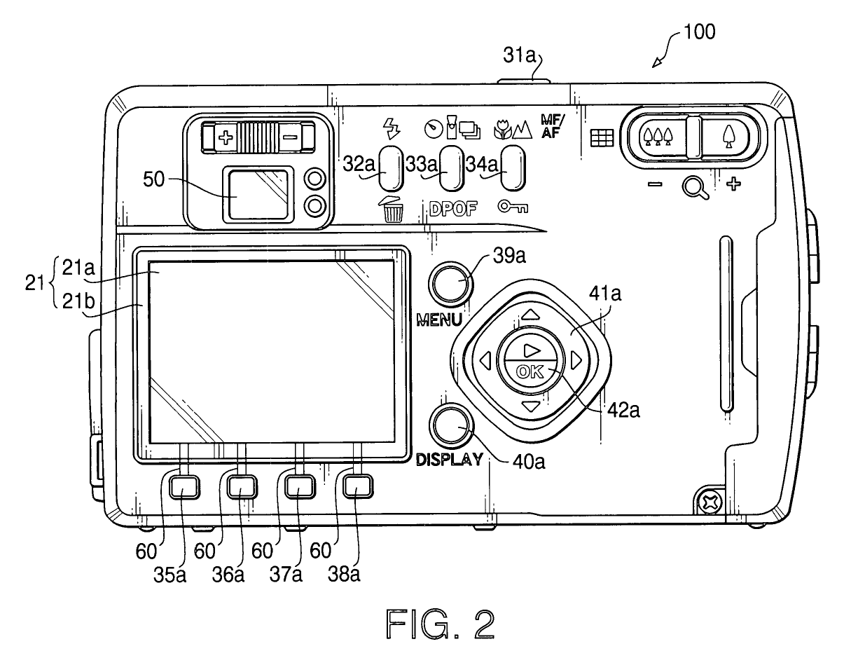

It should be noted that the above-described switches are associated with buttons that are provided on a rear surface of the camera body. FIG. 2 shows a plane view of the rear surface of a camera body of the digital camera 100 according to the embodiment of the invention. As shown in FIG. 2, the rear surface of the camera body is provided with an optical finder 50 on an upper-left hand side, and with a first through a third drive buttons 32a, 33a, 34a on a right-hand side of the finder 50. The drive buttons 32a, 33a, 34a are respectively associated with the drive switches 32, 33, 34, and are pressed when the drive switches 32, 33, 34 are activated. On an upper surface of the camera body, a release button 31a that is in association with the release switch 31 is provided, and the release button 31a is pressed when the release switch 31 is activated. At a lower side of the finder 50, the LCD panel 21 is provided. Further at a lower side of the LCD panel 21 a first through a fourth selection buttons 35a, 36a, 37a, 38a (i.e., operation buttons) that are in association with the first through the fourth selection switches 35, 36, 37, 38 respectively are arranged horizontally in line. The selection buttons 35a, 36a, 37a, 38a are pressed when the selection switches 35, 36, 37, 38 are activated. It should be noted that the LCD panel 21 includes a display area 21a, wherein information including the object image and the setting screen is shown, and a frame 21b that surrounds the display area 21a.

It should be further noted that the rear surface of the camera body is provided with four fixed lines 60, 60, 60, 60, which connect the selection buttons 35a, 36a, 37a, 38a with the display area 21a of the LCD panel 21 respectively. In the present embodiment, each of the four fixed lines 60, 60, 60, 60 is formed with two thinner lines, which are extended from each of the selection buttons 35a, 36a, 37a, 38a over the frame 21b to the display area 21a. It should be noted that the fixed lines 60, 60, 60, 60 may be formed by printing the lines in a color that is different from a color of the surroundings, and/or may be embossed or indented to form the lines.

Further, on a right-hand side of the LCD panel 21 are provided a menu button 39a, a display button 40a, a cursor key 41a, and an enter button 42a. The menu button 39a is in association with the menu switch 39, and is pressed when the menu switch 39 is activated. The display button 40a is in association with the display switch 40, and is pressed when the display switch 40 is activated. The cursor key 41a is formed to have an opening in a central portion thereof, and to have four peripheral portions, each of which is in association with one of the four cursor switches corresponding to one of the four directions. When the cursor shown on the LCD panel 21 is to be moved in one of the four directions, one of the four peripheral portions corresponding to the direction is pressed. The enter button 42a, which is arranged in the central opening of the cursor key 41a, is pressed when the enter switch 42 is activated. It should be noted that the cursor key 41a may not necessarily have the central opening, and the enter button 42a may not necessarily be arranged in the central opening of the cursor key 41a, but may be arranged separately from the cursor key 41a.

When the digital camera 100 is used, the power switch 30 is activated by pressing a power button (not shown). With this operation, the camera controller 1 controls the CCD driver 12 and starts an image capturing process, wherein an object image is captured through the image capturing element 11. Then, the captured image is output from the image capturing element 11 as image signals, which are processed by the image processing circuit 13 and displayed as the object image on the LCD panel 21. The camera controller 1 repeats the process and continuously displays the captured object images until the release button 31a is pressed. When the release button 31a is pressed, the release switch 31 is activated, and the activation is detected by the camera controller 1. Then the camera controller 1 controls a focusing system (not shown) and captures an image, which is processed as image signals and stored in the image memory 20.

It should be noted that the LCD panel 21 can serve as a finder during a normal photographing process as described above. However, when the optical finder 50 is selectively used, for example when the images are not required to be displayed on the LCD panel 21, the display button 40a is pressed to activate the display switch 40. With this operation, the camera controller ceases displaying the images on the LCD panel 21. Displaying the images on the LCD panel 21 is resumed when the display switch 40 is pressed again.

When the operation setting of the digital camera 100 is changed, one of the switches described above that is assigned the function to be performed is operated. For the functions assigned to the first drive switch 32, the second drive switch 33, and the third drive switch 34, the first drive button 32a, the second drive button 33a, and the third drive button 34a are respectively pressed. For another functions, the menu button 39a is pressed to bring the setting screen displayed on the LCD panel 21, and the user selectively presses one of the first through the fourth selection buttons 35a, 36a, 37a, 38a, the cursor key 41a, and the enter button 42a according to the desired function.

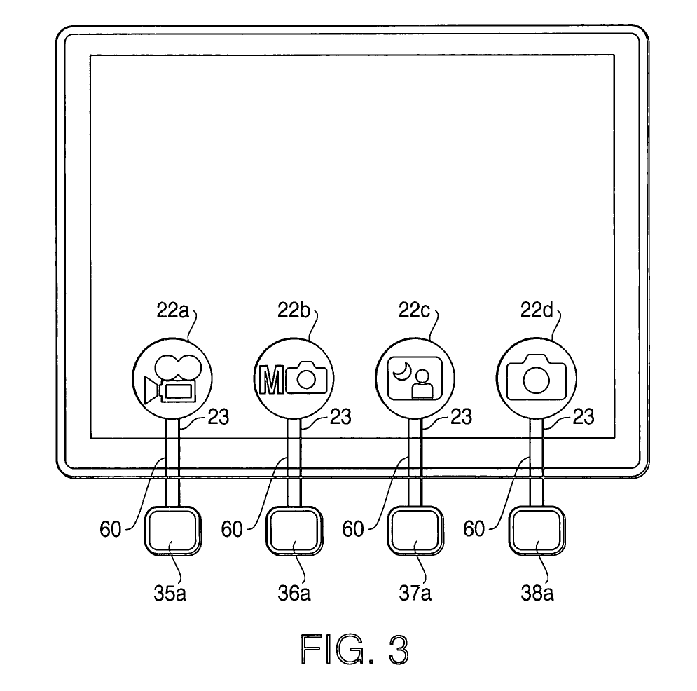

Hereinafter, a process for setting a desired photographing mode will be described. FIG. 3 shows an enlarged view of the LCD panel 21 and surroundings thereof according to the embodiment of the invention. When the menu button 39a is pressed for a predetermined number of times, the camera controller 1 displays a selection screen on the LCD panel 21 for selecting a photographing mode. In the present embodiment, as shown in FIG. 3, four graphic symbols, or icons, 22a, 22b, 22c, 22d (as function indexes) respectively representing the photographing modes are displayed. The icon 22a represents a function to start a video recording mode. The icon 22b represents a function to start a multiple exposure mode, the icon 22c represents a function to start a night photographing mode, and the icon 22d represents a function to start a regular photographing mode. It should be noted that these icons 22a, 22b, 22c, 22d are arranged adjacent to the selection buttons 35a, 36a, 37a, 38a respectively. It should be further noted that displayed lines 23, 23, 23, 23 are displayed at a lower side of the LCD panel 21, and the displayed lines 23, 23, 23, 23 are respectively connected to the fixed lines 60, 60, 60, 60, which are extended from each of the selection buttons 35a, 36a, 37a, 38a.

Thus, the icons 22a, 22b, 22c, 22d on the LCD panel 21 are visually connected to the selection buttons 35a, 36a, 37a, 38a respectively via the displayed lines 23, 23, 23, 23 and the fixed lines 60, 60, 60, 60, so that the user can apprehend the correspondence of the icons 22a, 22b, 22c, 22d with the selection buttons 35a, 36a, 37a, 38a. When the user selects one of the selection buttons 35a, 36a, 37a, 38a that is provided with the function corresponding to the desired photographing mode and presses the same, the desired mode is initiated.

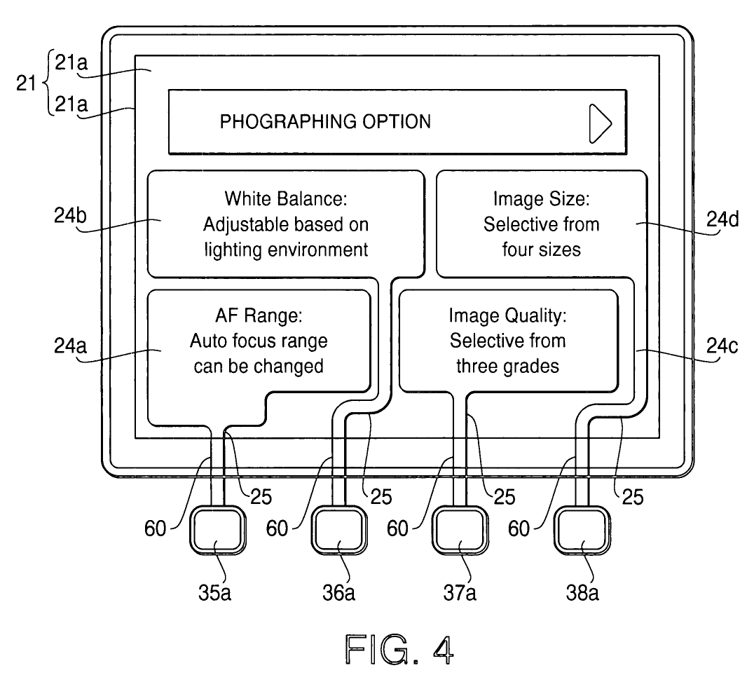

Hereinafter, a process for setting a photographing option will be described. FIG. 4 shows another enlarged view of the LCD panel 21 and surroundings thereof according to the embodiment of the invention. When the menu button 39a is pressed for a predetermined number of times, the camera controller 1 displays a selection screen on the LCD panel 21 for selecting a photographing option. In the present embodiment, as shown in FIG. 4, four description balloons 24a, 24b, 24c, 24d (as function indexes) respectively describing the functions to set the photographing options are displayed. Each of the description balloons 24a, 24b, 24c, 24d is adapted to contain a text to explain briefly the function assigned to one of the selection buttons 35a, 36a, 37a, 38a, and when the user selectively presses one of the selection buttons 35a, 36a, 37a, 38a, the user is allowed to set the photographing option. The description balloon 24a contains a text “AF Range: Auto focus range can be changed,” and indicates the first selection button 35a is assigned a function to set an auto focus range. The description balloon 24b contains a text “White Balance: Adjustable based on lighting environment,” and indicates the second selection button 36a is assigned a function to adjust white balance. The description balloon 24c contains a text “Image Quality: Selective from three grades,” and indicates the third selection button 37a is assigned a function to set an image quality of photographing. The description balloon 24d contains a text “Image Size: Selective from four sizes,” and indicates the fourth selection button 38a is assigned a function to set a size of the image to be photographed. It should be noted that the description balloons 24a, 24b, 24c, 24d are respectively provided with displayed lines 25, 25, 25, 25 that visually connect the description balloons 24a, 24b, 24c, 24d with the fixed lines 60, 60, 60, 60, thus the description balloons 24a, 24b, 24c, 24d are visually connected with the selection buttons 35a, 36a, 37a, 38a.

It should be noted that four subsidiary menus belong to the selection screen, and each of the subsidiary menus allows the user to configure the photographing option that the user selected in the selection screen. Therefore, when the user reads the descriptions indicated in the description balloons 24a, 24b, 24c, 24d and selectively presses one of the selection buttons 35a, 36a, 37a, 38a that is assigned the desired function, the function is performed and the user is allowed to configure the photographing option by operating one or more of the selection buttons 35a, 36a, 37a, 38a, and the cursor key 41a, and the enter button 42a.

It should be noted that when the description of the function corresponding to one of the selection buttons 35a, 36a, 37a, 38a contains a greater number of letters or characters, as shown in FIG. 4, the description balloons 24a, 24b, 24c, 24d tend to be larger in size, and it may be difficult to display all of the description balloons 24a, 24b, 24c, 24d adjacent to the corresponding selection buttons 35a, 36a, 37a, 38a. However, with the above-described configuration, the description balloons 24a, 24b, 24c, 24d being visually connected with the selection buttons 35a, 36a, 37a, 38a respectively can be fully displayed on the LCD panel 21, and the user can apprehend the correspondence of the description in the description balloons 24a, 24b, 24c, 24d to the selection buttons 35a, 36a, 37a, 38a. In other words, with the above-described configuration, the correspondence of the operational functions to the selection buttons 35a, 36a, 37a, 38a can be apprehended promptly regardless of positions of the description balloons 24a, 24b, 24c, 24d on the LCD panel 21, and descriptions of a plurality of functions can be effectively displayed on the LCD panel 21 regardless of an aspect ratio of the LCD panel 21. It should be further noted that graphic symbols such as icons 22a, 22b, 22c, 22d shown in FIG. 3 are effective in representing the functions assigned to the selection buttons 35a, 36a, 37a, 38a in a small area, although these symbols generally require the user to memorize what the symbols represent, therefore the symbols may not be user-friendly. However, the user can read the descriptions such as those indicated in the description balloons 24a, 24b, 24c, 24d in FIG. 4 to apprehend the functions assigned to the selection buttons 22a, 22b, 22c, 22d, therefore the user can be released from the requirement of memorizing.

The present disclosure relates to the subject matter contained in Japanese Patent Application No. 2005-061206, filed on Mar. 4, 2005, which is expressly incorporated herein by reference in its entirety.

What is claimed is:

1. An operation unit for a portable device, comprising:
a display panel with a display area that is arranged on a body of the portable device and is adapted to electrically display arbitrary information,
a plurality of operation buttons that are arranged in a vicinity of the display panel on the body of the portable device,
a plurality of fixed lines, each of which is extended from each of the plurality of operation buttons to the display area of the display panel,
a display controlling system that is adapted to control an operation of the portable device,
wherein the display controlling system displays function indexes, each of which indicates a function assigned to one of the plurality of the operation buttons based on an operation mode that the device is in so that each of the function indexes is displayed in an independent area on the display panel, and
wherein the display controlling system displays a plurality of displayed lines, each of which is displayed on the display area of the display panel to visually connect the independent area of the display panel to one of the plurality of operation buttons that is assigned the function.

2. The operation unit according to claim 1, wherein each of the function indexes is a graphic symbol that represents the function assigned to one of the plurality of operation buttons.

3. The operation unit according to claim 1, wherein each of the function indexes is a descriptive text that explains the function assigned to one of the plurality of operation buttons.

4. A digital camera comprising:
an operation unit having a display panel with a display area that is arranged on a body of the digital camera, the display panel being adapted to electrically display arbitrary information, a plurality of operation buttons that are arranged in a vicinity of the display panel on the body of the digital camera, a plurality of fixed lines, each of which is extended from each of the plurality of operation buttons to the display area of the display panel, a display controlling system that is adapted to control an operation of the digital camera,
wherein the display controlling system displays function indexes, each of which indicates a function assigned to one of the plurality of the operation buttons based on an operation mode that the digital camera is in so that each of the function indexes is displayed in an independent area on the display panel, and
wherein the display controlling system displays a plurality of displayed lines, each of which is displayed on the display area of the display panel to visually connect the independent area of the display panel to one of the plurality of operation buttons that is assigned the function.

5. The digital camera according to claim 4, wherein each of the function indexes is a graphic symbol that represents the function assigned to one of the plurality of operation buttons.

6. The digital camera according to claim 4, wherein each of the function indexes is a descriptive text that explains the function assigned to one of the plurality of operation buttons.

7. A portable device comprising:
an operation unit having a display panel with a display area that is arranged on a body of the portable device, the display panel being adapted to electrically display arbitrary information, a plurality of operation buttons that are arranged in a vicinity of the display panel on the body of the portable device, a plurality of fixed lines, each of which is extended from each of the plurality of operation buttons to the display area of the display panel, a display controlling system that is adapted to control an operation of the portable device,
wherein the display controlling system displays function indexes, each of which indicates a function assigned to one of the plurality of the operation buttons based on an operation mode that the device is in so that each of the function indexes is displayed in an independent area of the display panel, and
wherein the display controlling system displays a plurality of displayed lines, each of which is displayed on the display area of the display panel to visually connect the independent area of the display panel to one of the plurality of operation buttons that is assigned the function.

8. The portable device according to claim 7, wherein each of the function indexes is a graphic symbol that represents the function assigned to one of the plurality of operation buttons.

9. The portable device according to claim 7, wherein each of the function indexes is a descriptive text that explains the function assigned to one of the plurality of operation buttons.
